(19) United States
(12) Patent Application Publication
(10) Pub. No.: US 2016/0224585 A1
(43) Pub. Date: Aug. 4, 2016

(54) CONTROLLER, WORKER TERMINAL, INFORMATION DELETION METHOD, AND PROGRAM

(71) Applicant: MITSUBISHI ELECTRIC CORPORATION, Tokyo (JP)

(72) Inventors: Noriyuki KOMIYA, Tokyo (JP); Satoshi MINEZAWA, Tokyo (JP); Masaaki YABE, Tokyo (JP); Ichiro MARUYAMA, Tokyo (JP); Hirotoshi YANO, Tokyo (JP)

(21) Appl. No.: 15/021,722

(22) PCT Filed: Nov. 12, 2013
(86) PCT No.: PCT/JP2013/080535

§ 371 Date: Mar. 14, 2016

(51) Int. Cl. G06F 17/30; H04L 29/06

(52) U.S. Cl. CPC G06F 17/30117; H04L 63/0876; G05B 2219/2639

(57) ABSTRACT

A data memory stores measurement data and the like of an electrical device installed in a residence. A communicator communicates with a worker terminal operated by a worker or a user terminal operated by a user. A worker terminal authenticator authenticates the worker terminal. A command receiving processor receives a command transmitted from the worker terminal or the user terminal. A command executing processor initializes the measurement data stored in the data memory only when the command is a command transmitted from the worker terminal authenticated by the authenticator, given in an installation work, and instructing an initialization.

### TECHNICAL FIELD

The present disclosure relates to a controller, a worker terminal, an information deletion method, and a program.

### BACKGROUND ART

Recently, home network systems that have various electrical devices connected to one another based on a predetermined communication standard are becoming more prevalent in ordinary homes. According to such home network systems, electrical devices, such as an air conditioner, a lighting device, a rice cooker, an IH cooking device, and an air dehumidifier, are communicably connected with a controller, and the electrical devices are manageable (for example, integration of amount of power consumption, and control in accordance with schedule) via the controller.

According to such home network systems, at the time of, for example, an initial installation work, a worker actually activates an electrical device, and carries out an adjustment that includes a set-up, and a general operation check. When a check result does not show any problem, the worker hands over the system to a user after deletion (including initialization) of information like measurement data from the controller. That is, because of an activation prior to the hand-over, an amount of power consumption, and the like of an electrical device is measured, and such measurement data (for example, an integrated power amount) is stored in the controller, and thus the worker initializes such information. In addition, after the system is handed over, there are cases in which the user makes a replace purchase of the electrical device. At the time of maintenance work for such electrical device replacement, the worker deletes information from the controller after the installation of the new replacement electrical device and an operation check thereof.

For example, Patent Literature 1 discloses, as a conventional technology to delete information while performing maintenance work, and the like, a power management system that facilitates a deletion of information. According to this power management system, when an operation to change a user is given, necessary information for the maintenance of equipment (for example, a record of an amount of power generation and a total operation time) is left for the next user who will take over the system, and only information relating to the former user (for example, an amount of power consumption and an amount of purchase and sale power) is deleted.

### CITATION LIST

### Patent Literature

Patent Literature 1: Unexamined Japanese Patent Application Kokai Publication No. 2013-045376

### SUMMARY OF INVENTION

### Technical Problem

According to the technology disclosed in Patent Literature 1, since a general user is capable of giving an operation to change the user, information may be deleted against the will of the user. When, for example, incorrect password is entered multiple times, the power management system disclosed in Patent Literature 1 deletes even the information on the current user because of a function that does not allow the current user to review information on the previous user. In addition, at the time of an installation work and of a maintenance work, when the worker should give an operation to change the user prior to the hand-over of the system, if the worker forgets to carry out such an operation, information that should normally be deleted still remains after the hand-over. Hence, the measurement data to be managed may become inaccurate, and personal information, and the like, may be revealed to a third party.

The present disclosure is made in view of the aforementioned circumstances, and an objective of the present disclosure is to provide a controller, a worker terminal, an information deletion method, and a program that are capable of appropriately deleting information while enhancing a security.

### Solution to Problem

In order to accomplish the above objective, a controller according to the present disclosure is configured to manage an electrical device installed in a residence, the controller including:

a communicator configured to communicate with a worker terminal operated by a worker, or a user terminal operated by a user;

an authenticator configured to authenticate the worker terminal to be communicated with the communicator;

a command executing processor configured to execute a process in accordance with a command transmitted from the worker terminal authenticated by the authenticator or the user terminal; and

a memory configured to store various pieces of information relating to the electrical device,

in which:

the command executing processor is configured to, only when the command is transmitted from the worker terminal authenticated by the authenticator and is for instructing a deletion of information defined in accordance with a work, delete the instructed information among the pieces of information stored in the memory.

### Advantageous Effects of Invention

According to the present disclosure, information can be appropriately deleted while enhancing security.

### BRIEF DESCRIPTION OF DRAWINGS

FIG. 1 is a block diagram illustrating an example structure of a home network system according to an embodiment of the present disclosure;

FIG. 2 is a block diagram illustrating an example structure of a worker terminal;

FIG. 3 is a schematic diagram illustrating an example work screen;

FIG. 4 is a block diagram illustrating an example structure of a user terminal;

FIG. 5 is a block diagram illustrating an example structure of a controller;

FIG. 6 is a schematic diagram illustrating example unique information and personal information stored in a memory;

FIG. 7 is a schematic diagram illustrating example measurement data stored in the memory;

FIG. 8 is a sequence diagram illustrating an example basic sequence between the worker terminal and the controller;

FIG. 9 is a sequence diagram illustrating a specific example of the basic sequence;

FIG. 10 is a block diagram illustrating an example structure of a worker terminal according to a second embodiment of the present disclosure;

FIG. 11 is a schematic diagram illustrating example work procedure information stored in a memory;

FIG. 12 is a schematic diagram illustrating example measurement data according to a third embodiment of the present disclosure; and

FIG. 13 is a graph for explaining an integrated power amount when an offset value is applied.

### DESCRIPTION OF EMBODIMENTS

Embodiments of the present disclosure is explained below. In the following explanation, in order to facilitate understanding, example embodiments in which the present disclosure is applied to a controller, and the like, is explained, but the present disclosure is also applicable to information processing devices, such as various computers, PDAs, and mobile phones. That is, embodiments explained below are merely intended to explain, and are not intended to limit the scope and spirit of the present disclosure. Hence, a person of ordinary skill in the art can adopt an embodiment in which each of or all of components are replaced with equivalents, and such embodiment is also within the scope and spirit of the present disclosure.

### First Embodiment

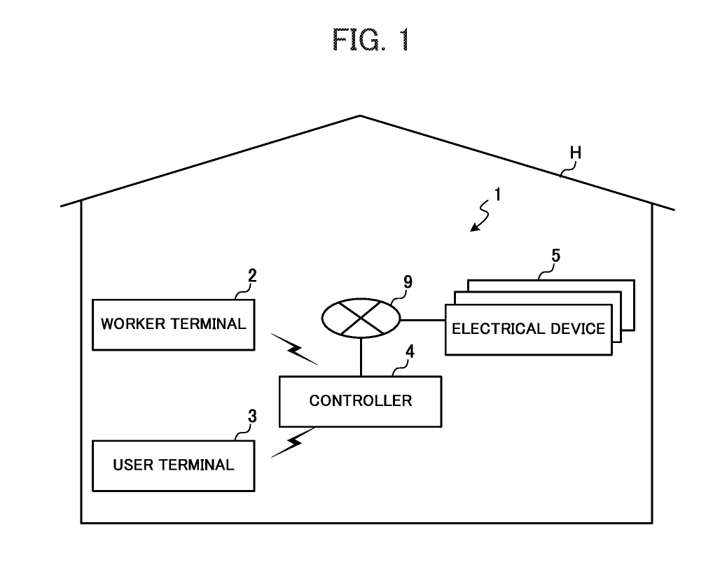

FIG. 1 is a block diagram illustrating an example structure of a home network system 1 according to a first embodiment of the present disclosure. This home network system 1 is, as an example, a system that manages each electrical device 5 installed in a residence H, and includes a worker terminal 2, a user terminal 3, a controller 4, and the multiple electrical devices 5. Among those components, the controller 4 and each of the electrical devices 5 are communicably connected with each other via an in-home network 9 (for example, wired or wireless network). In addition, the worker terminal 2 and the controller 4, and, the user terminal 3 and the controller 4 are also communicably connected with each other via, for example, a wireless LAN. Note that the worker terminal 2 and the user terminal 3 may be also communicably connected to the controller 4 via the in-home network 9.

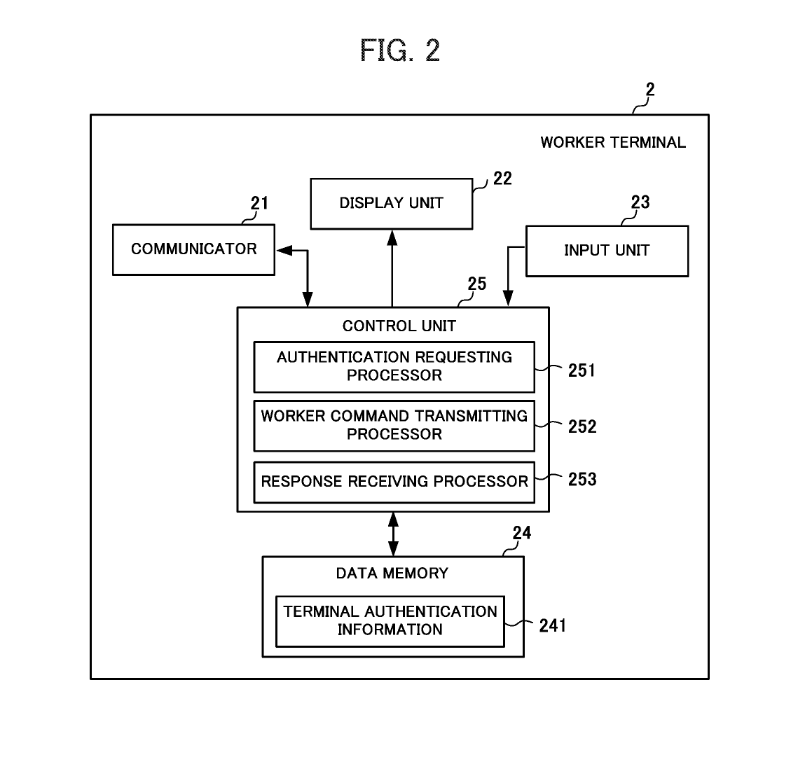

The worker terminal 2 is, for example, a mobile terminal, such as a tablet terminal or a smartphone, and is utilized by a worker who carries out an installation work of the electrical device 5 and a maintenance work thereof. Note that the installation work is a work carried out before the home network system 1 is handed over to a user, and for example, the worker actually activates the electrical device 5, and carries out an adjustment including a set-up and a general operation check. Also note that the maintenance work is a work carried out when, for example, the user makes a replacement purchase of the electrical device 5 after the home network system 1 is handed over to such a user, and for example, the worker installs the new replacement electrical device 5 and carries out an operation check thereof. An example structure of the worker terminal 2 utilized at the time of those works is explained below with reference to FIG. 2 which is a block diagram. As illustrated in the figure, the worker terminal 2 includes a communicator 21, display unit 22, input unit 23, a data memory 24, and a control unit 25.

The communicator 21 includes, for example, an interface for a wireless LAN connection that conforms to Wi-Fi (registered trademark) standards, and performs data communication with the controller 4 under the control of the control unit 25.

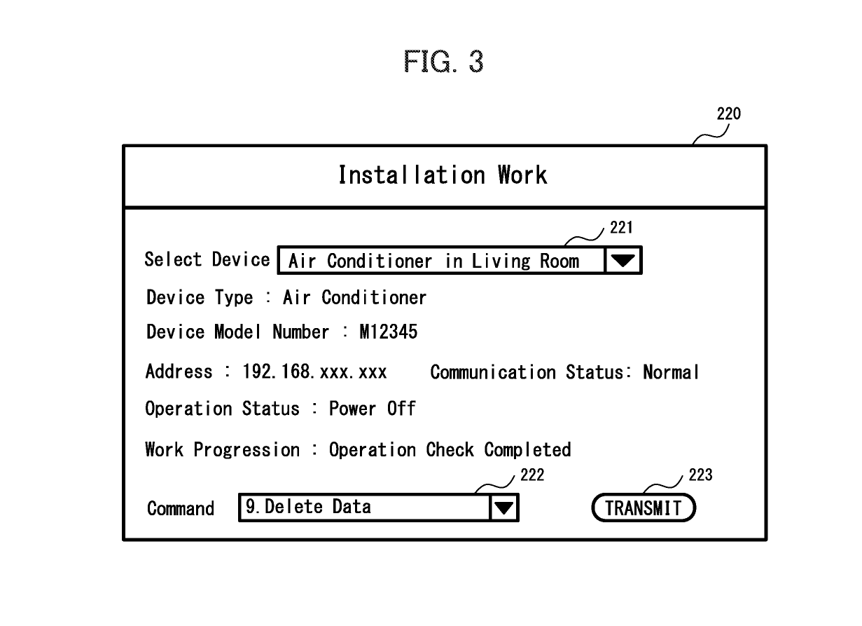

The display unit 22 includes a liquid crystal panel or the like, and displays various screens, and the like under the control of the control unit 25. More specifically, the display unit 22 displays a work screen 220 illustrated in FIG. 3. This work screen 220 is, for example, a screen presented when the worker carries out an installation work of the electrical device 5, and includes, for example, a dropdown list 221 to select the device, a dropdown list 222 to select a command to be transmitted to the controller 4, and a button 223 to instruct a transmission of the selected command Note that the details of the command to be transmitted to the controller 4 are explained further below together with the control unit 25 (worker command transmitting processor 252).

Referring back to FIG. 2, the input unit 23 includes a touch panel, a touch pad, and the like, and accepts an operation input made by the user. When, for example, the input unit 23 is a touch panel, an electrostatic capacitance sensor which is a transparent plate component, and which detects a change in electrostatic capacitance is laid over on a liquid crystal display. When this electrostatic capacitance sensor detects a contact (pressing force) to a touchscreen (display screen of liquid crystal display for user) by a fingertip of the user or a dedicated pen, information on such a position (coordinate data) is output to the control unit 25. The control unit 25 determines the details of the operation given by the user based on the position information. When the user carries out an input operation via the input unit 23, signals in accordance with the details of the operation are supplied to the control unit 25.

The data memory 24 has a role of a so-called secondary memory device (auxiliary memory device), and includes, for example, a non-volatile readable and writable semiconductor memory like a flash memory. The data memory 24 stores terminal authentication information 241 that is necessary for an authentication of the worker terminal 2. This terminal authentication information 241 is information indicating that the local device is the “worker terminal” In addition, the data memory 24 stores, for example, a program to be executed by the control unit 25.

The control unit 25 includes a Central Processing Unit (CPU), a Read Only Memory (ROM), a Random Access Memory (RAM), and the like (all unillustrated), and controls each of the above-explained components. The control unit 25 includes, as a functional structure, an authentication requesting processor 251, a worker command transmitting processor 252, and a response receiving processor 253. These functions are realized by the CPU which utilizes the RAM as a work memory, and which executes various programs as needed stored in the ROM and the data memory 24.

The authentication requesting processor 251 requests the controller 4 to authenticate the terminal via the communicator 21. That is, the authentication requesting processor 251 requests the controller 4 to authenticate the worker terminal 2 so as to permit only the worker (worker terminal 2) to transmit worker commands Next, the authentication requesting processor 251 reads the terminal authentication information 241 from the data memory 24, and transmits the read information to the controller 4. Note that the details of the authentication of the worker terminal 2 are explained further below together with the controller 4 (control unit 43).

The worker command transmitting processor 252 transmits worker commands by the worker that instruct the controller 4 to perform necessary operations during the installation work and in the maintenance work. More specifically, when a command is selected via the dropdown list 222, and the button 223 that instructs a transmission of the command is pressed by the worker in the work screen 220 illustrated in FIG. 3, the worker command transmitting processor 252 transmits the corresponding worker command to the controller 4.

During the installation work, for example, the worker command transmitting processor 252 transmits a command to set up the electrical device 5, a command to check the operation of the electrical device 5, and a command to delete (initialize) measurement data on the electrical device 5. Note that because of the activation of the electrical device 5 during the installation work, an amount of power consumption, and the like of the electrical device 5 has already been measured, and the measurement data (for example, integrated power amount) has already been stored in the controller 4 (data memory 42 is explained further below), a command to delete the measurement data is a command to initialize such measurement data. In addition, in the case of the maintenance work, the worker command transmitting processor 252 transmits, for example, a command to set up the new replacement electrical device 5, a command to check the operation of the electrical device 5, and a command to delete information unique to the former electrical device, and user's personal information relating to the former electrical device 5. Note that those commands are merely examples, and can be changed as needed in accordance with the details of the installation work and those of the maintenance work.

The response receiving processor 253 receives a response to be transmitted by the controller 4 and corresponding to the worker command transmitted to the controller 4 by the worker command transmitting processor 252. For example, the response receiving processor 253 receives a response like an execution result by the controller 4 that has executed an operation instructed in the worker command.

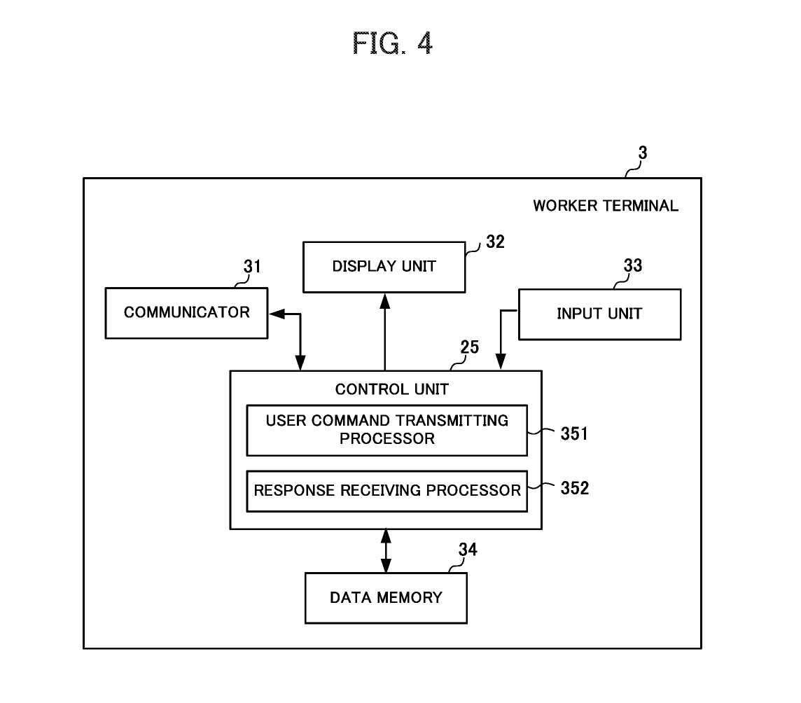

Referring back to FIG. 1, the user terminal 3 is a mobile terminal, such as a tablet terminal or a smartphone, and is utilized by the user like a resident of the residence H. Note that the user terminal 3 is not limited to such a mobile terminal, and may be a stationary terminal. As for an example structure of the user terminal 3, an explanation is given with reference to FIG. 4 which is a block diagram. As illustrated in the figure, the user terminal 3 includes a communicator 31, display unit 32, input unit 33, a data memory 34, and a control unit 35.

The communicator 31 includes, for example, an interface for a wireless LAN connection that conforms to Wi-Fi (registered trademark) standards, and performs data communication with the controller 4 under the control of the control unit 35. Note that the communication by the communicator 31 is not limited to the wireless communication, and communication via a wire like a wired LAN is also acceptable.

The display unit 32 includes a liquid crystal panel, and the like, and displays various screens, and the like under the control of the control unit 35. For example, the display unit 32 displays an activation status screen with respect to the electrical device 5 that is managed by the controller 4.

The input unit 33 includes a touch panel, a touch pad, and the like, and accepts an operation input made by the user.

The data memory 34 has a role of a so-called secondary memory device (auxiliary memory device), and includes, for example, a non-volatile readable and writable semiconductor memory like a flash memory. The data memory 34 stores a program to be executed by the control unit 35, and various information necessary to execute the program. Note that the data memory 34 does not contain the terminal authentication information 241 stored in the worker terminal 2 (data memory 24). That is, a terminal authentication from the user terminal 3 is disabled.

The control unit 35 includes a CPU, a ROM, a RAM, and the like (all unillustrated), and controls each of the above-explained components. The control unit 35 includes, as a functional structure, a user command transmitting processor 351, and a response receiving processor 352. Those functions are realized by the CPU which utilizes the RAM as a work memory and which executes various programs as needed stored in the ROM and the data memory 34.

The user command transmitting processor 351 transmits a user command that instructs, from the user, the operation to be executed by the controller 4. For example, the user command transmitting processor 351 transmits a command to turn ON or OFF the electrical device 5, a command to display the operation status of the electrical device 5, and a command to change the operation of the electrical device 5. Note that those commands are merely examples, and can be changed as needed in accordance with the type of the electrical device 5. However, the commands to be transmitted by the user command transmitting processor 351 contain no worker command to be transmitted by the worker terminal 2 (worker command transmitting processor 252) as explained above. That is, the user command transmitting processor 351 is unable to transmit the command to delete the measurement data on the electrical device 5, and the command to delete the information unique to the electrical device 5 and the user's personal information relating to the electrical device 5.

The response receiving processor 352 receives a response to be transmitted by the controller 4 and corresponding to the user command transmitted to the controller 4 by the user command transmitting processor 351. For example, the response receiving processor 352 receives a response like an execution result by the controller 4 that has executed an operation instructed in the worker command.

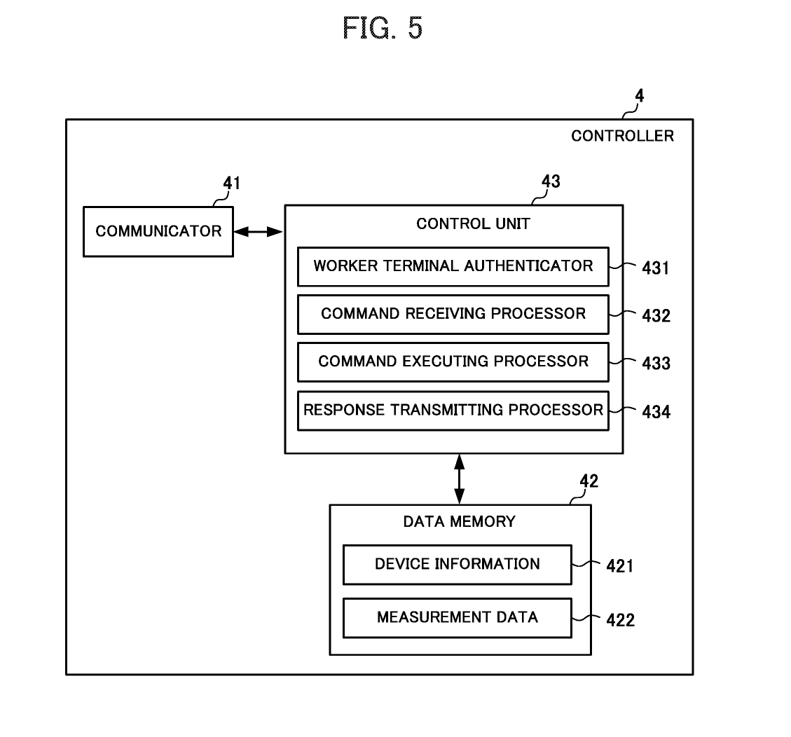

Referring back to FIG. 1, the controller 4 is, for example, a Home Energy Management System (HEMS) controller, and controls the entire home network system 1. An example structure of the controller 4 is explained below with reference to FIG. 5 which is a block diagram. As illustrated in the figure, the controller 4 includes a communicator 41, a data memory 42, and a control unit 43.

The communicator 41 performs data communication with each electrical device 5 via the in-home network 9. In addition, the communicator 41 performs data communication with the worker terminal 2 and the user terminal 3 via a wireless LAN, or the like.

The data memory 42 has a role of a so-called secondary memory device (auxiliary memory device), and includes, for example, a non-volatile readable and writable semiconductor memory like a flash memory. The data memory 42 stores device information 421, and measurement data 422 both explained further below. In addition to these pieces of information, the data memory 42 stores a program, and the like to be executed by the control unit 43.

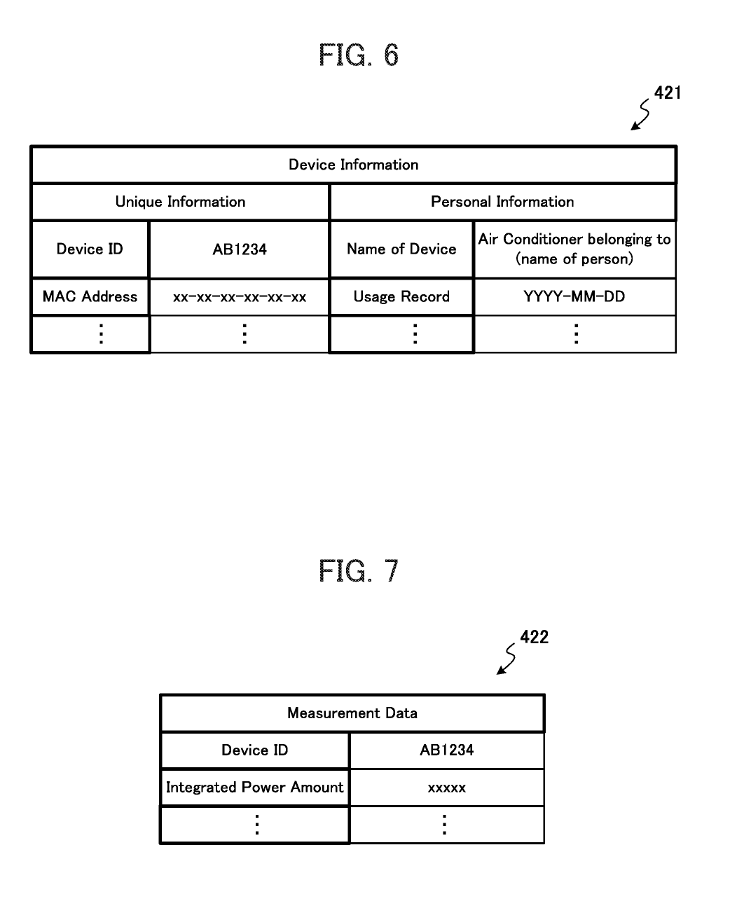

First, an explanation is given of the device information 421 with reference to FIG. 6. FIG. 6 is a schematic diagram illustrating example device information 421. This device information 421 contains the information unique to the electrical device 5 and the user's personal information relating to the electrical device 5. The information unique to the electrical device 5 is, for example, a device ID or a MAC address. In addition to these pieces of information, installation location information on the device and an IP address thereof may be further contained. Conversely, the user's personal information relating to the electrical device 5 is, for example, a name of the device (for example, a name set by the user) or a usage record. In addition to these pieces of information, a login ID of the user, a password, and further a combination of secret question and answer when the user forgets the password, and the like may be also contained. Note that such device information 421 is merely an example, and can be changed as needed in accordance with the type of the electrical device 5.

Next, the measurement data 422 is explained with reference to FIG. 7. FIG. 7 is a schematic diagram illustrating example measurement data 422. This measurement data 422 contains an integrated power amount obtained by integrating the amount of power consumption of the electrical device 5. In addition to such information, the measurement data 422 may further contain a cumulative activation time obtained by cumulating the activation time of the electrical device 5. Note that such measurement data 422 is merely an example, and can be changed as needed in accordance with the type of the electrical device 5.

Referring back to FIG. 5, the control unit 43 includes a CPU, a ROM, a RAM, and the like (all unillustrated), and controls each component explained above. The control unit 43 includes, as a functional structure, a worker terminal authenticator 431, a command receiving processor 432, a command executing processor 433, and a response transmitting processor 434. The functions of these components are realized by the CPU which utilizes the RAM as a work memory, and which executes various programs stored in the ROM or the data memory 42 as needed.

The worker terminal authenticator 431 authenticates the worker terminal 2 in accordance with a request. When, for example, an authentication request is transmitted from the worker terminal 2 (above-explained authentication requesting processor 251), the worker terminal authenticator 431 requests the worker terminal 2 to transmit information indicating the “worker terminal” Next, the worker terminal authenticator 431 checks, after transmission of the terminal authentication information 241 from the worker terminal 2, the validity, and the like of such information, thereby authenticating the worker terminal 2.

The command receiving processor 432 receives a command transmitted from the worker terminal 2 or the user terminal 3. That is, the command receiving processor 432 receives the worker command transmitted from the worker terminal 2, and also receives the user command transmitted from the user terminal 3.

The command executing processor 433 executes an operation in accordance with a command received by the command receiving processor 432. When, for example, the worker command is received by the command receiving processor 432, the command executing processor 433 executes an operation necessary during the installation work or the maintenance work in accordance with the received worker command. As an example, in accordance with the command that instructs deletion (initialization) of measurement data (measurement data 422), the command executing processor 433 initializes the measurement data 422 stored in the data memory 42. In addition, in accordance with the command that instructs deletion of the information unique to the former electrical device 5 and the user's personal information relating to the former electrical device 5, the command executing processor 433 deletes the device information 421 stored in the data memory 42. Note that in the case of the command that instructs deletion of such information, information to be deleted is defined beforehand in accordance with the installation work and the maintenance work. For example, in the case of the installation work, the measurement data 422 is the information to be deleted, while in the case of the maintenance work, the device information 421 is the information to be deleted. Hence, the command executing processor 433 deletes the instructed information among the pieces of information stored in the data memory 42 only when the received command is a command that instructs deletion of information defined in accordance with the work. Conversely, when the user command is received by the command receiving processor 432, the command executing processor 433 controls the electrical device 5, and reads information therefrom in accordance with such a user command.

Note that the command executing processor 433 executes an operation in accordance with the worker command only when the worker command is transmitted from the worker terminal 2 that has been authenticated by the worker terminal authenticator 431. If the worker command is transmitted from the user terminal 3 that has not been authenticated by the worker terminal authenticator 431, the command executing processor 433 transmits an error response from the response transmitting processor 434 which are explained further below without executing the instructed operation.

The response transmitting processor 434 transmits a response in accordance with the executed operation by the above-explained command executing processor 433 to the transmission originator (worker terminal 2 or user terminal 3) of the command. When, for example, the command executing processor 433 has executed the worker command, the response transmitting processor 434 transmits an execution result thereof to the worker terminal 2. Likewise, when the command executing processor 433 has executed the user command, the response transmitting processor 434 transmits an execution result thereof to the user terminal 3.

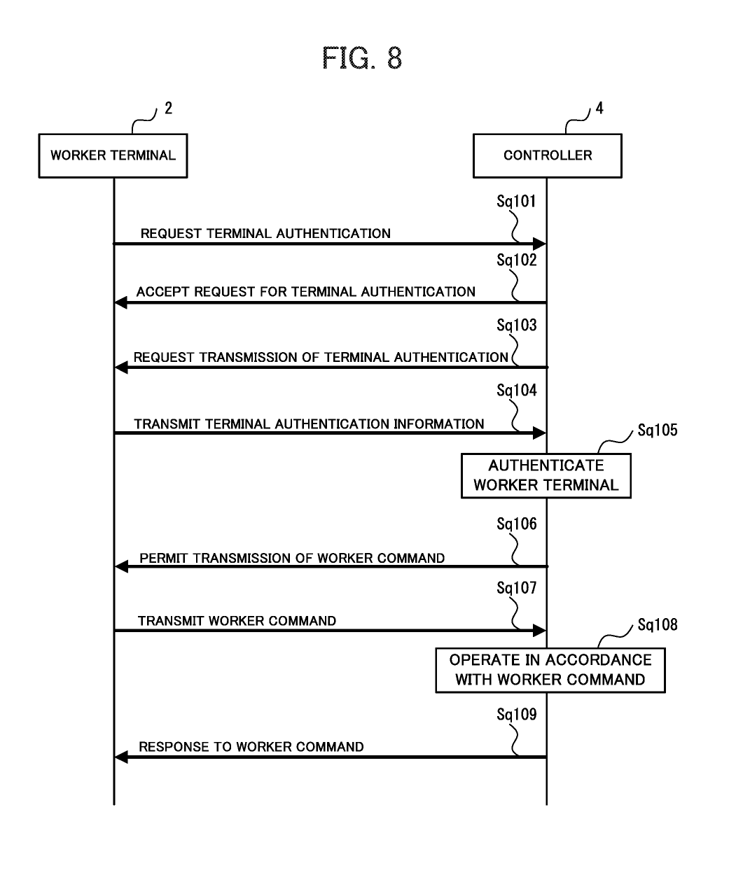

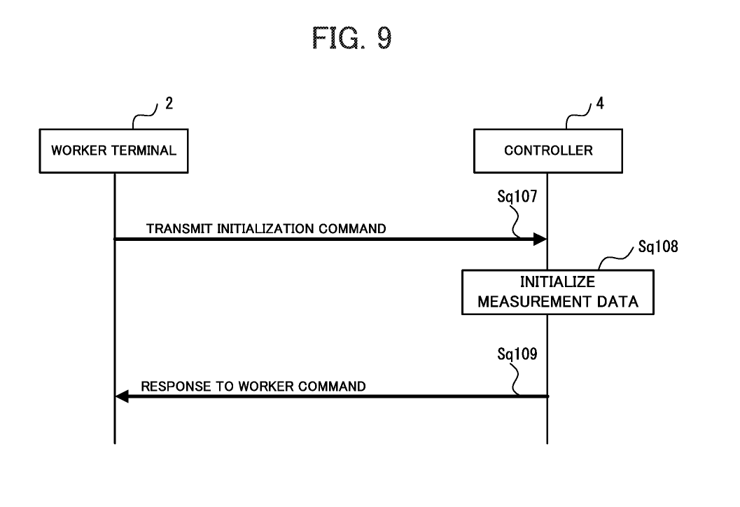

An explanation is given below of an operation of the home network system 1 with reference to FIG. 8 and FIG. 9. FIG. 8 is a sequence diagram illustrating an example basic sequence between the worker terminal 2 and the controller 4, while FIG. 9 is a sequence diagram illustrating a specific example of the basic sequence.

First, the basic sequence between the worker terminal 2 and the controller 4 is explained with reference to FIG. 8. First of all, the worker terminal 2 requests (Sq101) a terminal authentication to the controller 4. That is, the authentication requesting processor 251 requests the terminal authentication so as to permit the local worker terminal 2 to transmit the worker command.

When accepting the request for the terminal authentication (Sq102), the controller 4 requests (Sq103) the worker terminal 2 to transmit terminal authentication information (terminal authentication information 241 explained above). That is, the worker terminal authenticator 431 requests information indicating the “worker terminal” to the worker terminal 2.

The worker terminal 2 transmits (Sq104) the terminal authentication information (terminal authentication information 241) to the controller 4. That is, the authentication requesting processor 251 reads the terminal authentication information 241 from the data memory 24, and transmits the read information to the controller 4.

The controller 4 authenticates (Sq105) the worker terminal 2. That is, after checking the validity, and the like of the received terminal authentication information 241, the worker terminal authenticator 431 authenticates the worker terminal 2. Next, the controller 4 permits (Sq106) the worker terminal 2 to transmit the worker command.

Upon this permission-giving operation, the worker terminal 2 transmits (Sq107) the worker command to the controller 4. The controller 4 executes (Sq108) an operation in accordance with the received worker command, and then transmits (Sq109) a response to the worker terminal 2.

Next, such interactive operations from Sq107 to Sq109 are explained more specifically with reference to FIG. 9. FIG. 9 illustrates, as an example, a sequence when a command that instructs deletion (initialization) of the measurement data 422 is transmitted to the controller 4 during the installation work by the worker.

The worker terminal 2 transmits (Sq107) the initialization command of the measurement data 422 to the controller 4. That is, the worker command transmitting processor 252 transmits the command to initialize the measurement data 422 to the controller 4 since the amount of power consumption, and the like of the electrical device 5 is already measured through the activation of the electrical device 5 during the installation work, and the measurement data 422 is already stored in the data memory 42 of the controller 4.

The controller 4 initializes (Sq108) the measurement data (measurement data 422) in accordance with the received initialization command That is, the command executing processor 433 initializes the measurement data 422 stored in the data memory 42. Next, the controller 4 transmits (Sq109), to the worker terminal 2, a response to the effect that the initialization of the measurement data 422 has completed. That is, the response transmitting processor 434 transmits, to the worker terminal 2, a response indicating that the measurement data 422 in the data memory 42 has been initialized.

With reference to FIG. 9, explanation is given of the worker command (initialization command) transmitted during the installation work as an example, but other obtainment transmitted during the maintenance work are likewise processed. When, for example, during the maintenance work, a command that instructs deletion of the information unique to the former electrical device 5 or the user's personal information relating to the former electrical device 5 is transmitted in Sq107 from the worker terminal 2, the command executing processor 433 deletes (Sq108) the device information 421 stored in the data memory 42. Next, the response transmitting processor 434 transmits, to the worker terminal 2, a response indicating that the deletion of the device information 421 has completed.

Such interactive operations between the worker terminal 2 and the controller 4 come into effect based on an assumption that the terminal authentication has been carried out successfully. Hence, for example, the user terminal 3 that has not undergone a terminal authentication does not transmit a worker command to the controller 4. That is, the device information 421 and the measurement data 422 both stored in the controller 4 (data memory 42) are not deleted against the will of the user who operates the user terminal 3. In addition, even if the user terminal 3 transmits a worker command, since such a user terminal has not undergone the terminal authentication, as explained above, the command executing processor 433 causes the response transmitting processor 434 to return an error response without executing the instructed operation. That is, a dishonest act (for example, falsification of information affecting billing) of the user becomes preventable. Consequently, appropriate deletion of information is enabled while enhancing a security.

### Second Embodiment

According to the first embodiment, the worker command is transmitted from the worker terminal 2 to the controller 4, and the controller 4 is capable of, for example, deleting (including initialization) information in the data memory 42 in accordance with such a worker command. However, because of, for example, an operation mistake by the worker, the work may conclude without a transmission, from the worker terminal 2 to the controller 4, of a worker command necessary during the installation work or the maintenance work. Hence, a work procedure for the worker may be managed at the end of the worker terminal 2.

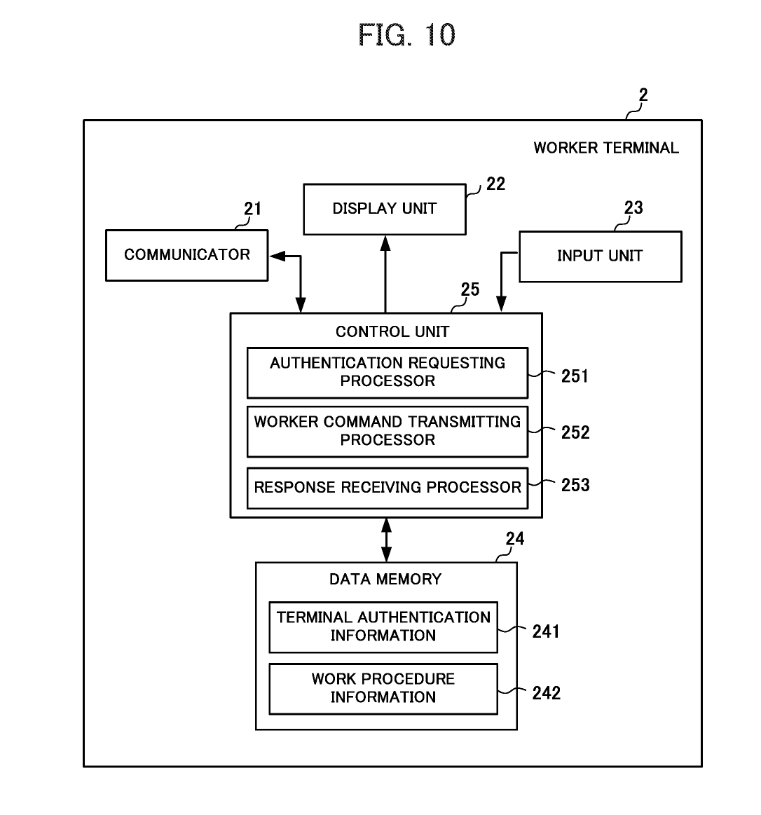

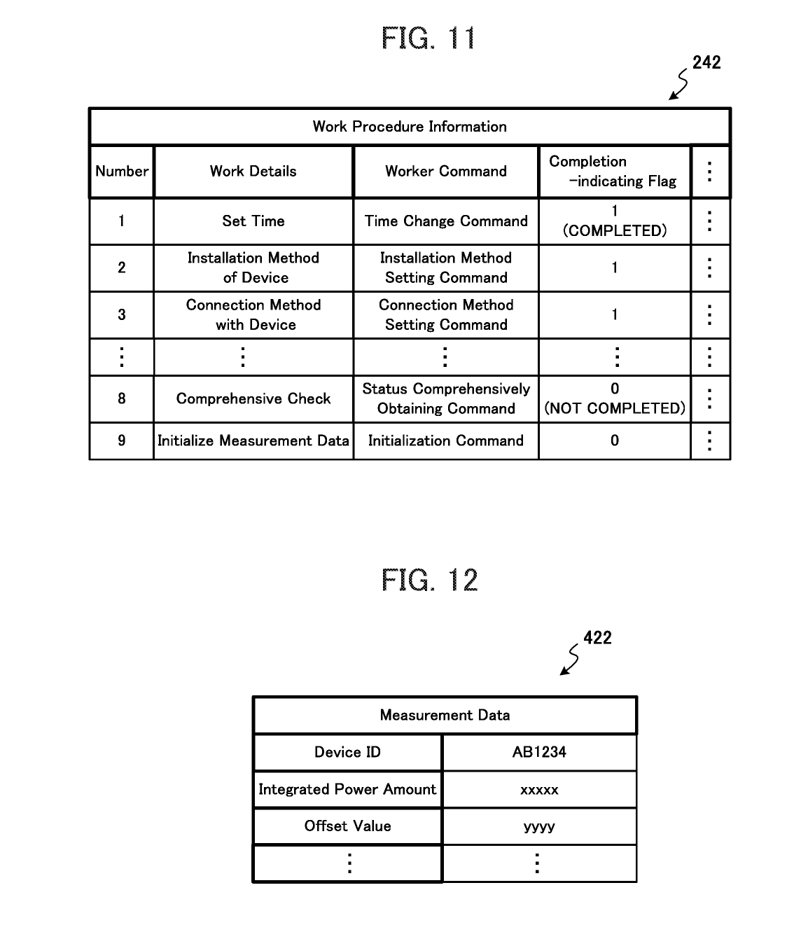

In a second embodiment, as illustrated in FIG. 10, the worker terminal 2 differs from the worker terminal 2 of the first embodiment in that a work procedure information 242 is further stored in the data memory 24. The work procedure information 242 is information that defines the sequential work details, and as an example, as illustrated in FIG. 11, the work procedure information 242 contains a number, a work detail, a worker command, and a completion-indicating flag. In this FIG. 11, the sequential work details at the time of installation work are defined, and the work details are presented to the worker in the order of number (ascending order). When the worker carries out the defined operation in accordance with the presented work details, a corresponding worker command is transmitted to the controller 4 from the worker command transmitting processor 252. Next, when the response receiving processor 253 receives a normal response, the completion-indicating flag is set. In addition, when all completion-indicating flags in the work procedure information 242 are not set yet, the worker terminal 2 does not accept a completion of the work.

As explained above, according to the second embodiment, the work procedure for the worker is managed based on the work procedure information 242, and thus a work procedure forgotten by the worker, and the like, is preventable. In addition, according to the second embodiment, explanation is given of an example case in which the work procedure information 242 is stored in the worker terminal 2 (data memory 24) to manage the work procedure for the worker, but such work procedure information 242 may be stored in the controller 4 (data memory 42), and the work procedure for the worker may be managed mainly by the controller 4. Still further, both the worker terminal 2 and the controller 4 may store the work procedure information 242, and may manage the work procedure for the worker by a mutual check up with each other.

### Third Embodiment

In the first embodiment, and the like, explanation is given of an example case in which the measurement data 422 stored in the controller 4 (data memory 42) at the time of installation work of the electrical device 5 is initialized. However, for the purpose of maintenance, and the like for the electrical device 5, information measured from the initial activation should be preferably left continuously in some cases. Hence, the measurement data 422 may be initialized so as to leave information from the initial activation.

In a third embodiment, as illustrated in FIG. 12, the controller 4 (data memory 42) differs from the controller 4 of the first embodiment in that the measurement data 422 containing an offset value is stored. As for the offset value in FIG. 12, when the measurement data 422 is initialized, a value of an integrated power amount at this time point is set. Note that at this time, the integrated power amount remains unchanged. That is, unlike the first embodiment in which the integrated power amount in the measurement data 422 is directly initialized, the offset value to be subtracted therefrom is updated to the same value, and thus the current integrated power amount obtained by the subtraction is initialized.

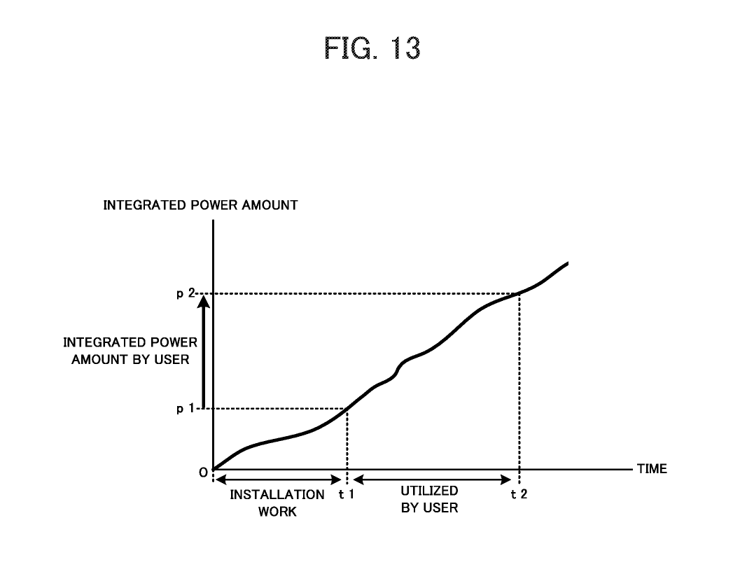

This is explained more specifically with reference to FIG. 13, and provided that the initialization command of the measurement data 422 is transmitted to the controller 4 from the worker terminal 2 at a time t1 in accordance with the completion of the installation work. In this case, the controller 4 (command executing processor 433) sets an integrated power amount p1 at the time point t1 to be the offset value in FIG. 12. That is, the current integrated power amount obtained by the subtraction becomes the integrated power amount−the offset value (that is, p1−p1), thus initialized to zero. Subsequently, the integrated power amount increases in accordance with the use by the user. Next, provided that, at a time t2, an obtaining command of the current integrated power amount is transmitted from the user terminal 3 to the controller 4. In this case, the controller 4 (command executing processor 433) obtains the current integrated power amount based on the integrated power amount−the offset value (that is, p2−p1), and transmits the obtained current integrated power amount to the user terminal 3.

As explained above, according to the third embodiment, information containing the offset value to be subtracted from the integrated power amount is contained in the measurement data 422, and when the measurement data 422 is initialized, the integrated power amount in the measurement data 422 is not directly initialized, but the offset value is updated to the value that is equal to the integrated power amount, and thus the current integrated power amount obtained by subtraction is initialized Hence, information measured from the initial activation of the electrical device 5 is left continuously, and thus such information is available for the maintenance work, and the like. Conversely, for the user (user terminal 3), the current integrated power amount obtained by subtracting the offset value from the integrated power amount in the measurement data 422 is transmitted, and thus data measured in accordance with the use by the user is appropriately providable.

In the foregoing embodiments, explanation is given of an example case in which the present disclosure is applied to the controller 4, and the like, but the present disclosure is realizable by not only a special-purpose system but also a normal computer system. For example, the controller 4 that executes the above-explained process may be configured by distributing a computer program to carry out the above-explained operations in a manner stored in a non-transitory computer-readable recording medium (for example, a flexible disk, a CD-ROM, or a DVD-ROM), and by installing the computer program in a computer. In addition, the controller 4 may be configured by storing the computer program in a storage device of a server device on a communication network like the Internet, and by downloading the computer program to a normal computer system.

In addition, when the functions of the controller 4 are shared by an Operating System (OS) and an application program, or are realized by a cooperative work of the OS with the application program, only the application program portion may be stored in a non-transitory recording medium or a storage device.

Still further, the computer program may be superimposed on carrier waves, and may be distributed via a communication network. For example, the computer program may be posted on a Bulletin Board System (BBS) on a communication network, and may be distributed via the network. Next, the computer program may be launched, and executed like other application programs under the control of the OS to enable execution of the above-explained processes.

### INDUSTRIAL APPLICABILITY

The present disclosure is appropriately applicable to a controller, a worker terminal, an information deletion method, and a program which are capable of appropriately deleting information while enhancing a security.

### REFERENCE SIGNS LIST

1 Home network system
2 Worker terminal
3 User terminal
4 Controller
5 Electrical device
9 In-home network
21, 31, 41 Communicator
22, 32 Display unit
23, 33 Input unit
24, 34, 42 Data memory
25, 35, 43 Control unit

1. A controller configured to manage an electrical device installed in a residence, the controller comprising:
a communicator configured to communicate with a worker terminal operated by a worker, or a user terminal operated by a user;
an authenticator configured to authenticate the worker terminal to be communicated with the communicator;
a command executing processor configured to execute a process in accordance with a command transmitted from the worker terminal authenticated by the authenticator or the user terminal; and
a memory configured to store various pieces of information relating to the electrical device,
wherein:
the command executing processor is configured to, only when the command is transmitted from the worker terminal authenticated by the authenticator and is for instructing a deletion of information stored in the memory, delete the instructed information among the pieces of information stored in the memory.

2. The controller according to claim 1, wherein:
the memory is configured to store measurement data containing a measured amount of power of the electrical device; and
the command executing processor is configured to, only when the command is transmitted from the worker terminal authenticated by the authenticator and is for initializing the measurement data of the electrical device, initialize the measurement data stored in the memory.

3. The controller according to claim 1, wherein:
the memory is configured to store information containing unique information of the electrical device and personal information of the user relating to the electrical device; and
the command executing processor is configured to, only when the command is transmitted from the worker terminal authenticated by the authenticator and is for deleting the unique information of the electrical device and the personal information of the user relating to the electrical device, delete the unique information and the personal information both stored in the memory.

4. The controller according to claim 1, wherein:
the memory is configured to store information containing an integrated power amount obtained by integrating measured amounts of power of the electrical device, and an offset value to be subtracted from the integrated power amount; and
the command executing processor is configured to, only when the command is transmitted from the worker terminal authenticated by the authenticator and is for initializing a current integrated power amount of the electrical device, set the integrated power amount stored in the memory to be the offset value, and initialize the current integrated power amount obtained by a subtraction.

5. A worker terminal configured to be communicable with a controller configured to manage an electrical device installed in a residence, the worker terminal comprising:
an authentication requesting processor configured to request the controller to perform an authentication;
a command transmitting processor configured to transmit a command to the controller having authenticated the worker terminal; and
a memory configured to store work procedure information defining sequential work details,
wherein:
the work procedure information stored in the memory contains, among various pieces of information relating to the electrical device and stored in the controller, a command to delete information stored in the memory; and
the command transmitting processor is configured to sequentially transmit commands to the controller having authenticated the worker terminal in accordance with the work procedure information stored in the memory.

6. An information deletion method by a controller comprising a memory configured to store various pieces of information relating to an electrical device installed in a residence, and configured to manage the electrical device, the information deletion method comprising:
communicating with a worker terminal operated by a worker, or a user terminal operated by a user;
authenticating the worker terminal to be communicated; and
executing a process in accordance with a command transmitted from the authenticated worker terminal, or the user terminal,
wherein:
the executing, only when the command is transmitted from the authenticated worker terminal and is for instructing a deletion of information stored in the memory, deletes the instructed information among the pieces of information stored in the memory.

7. (canceled)
